(19) United States
(12) Patent Application Publication
(10) Pub. No.: US 2010/0070262 A1
(43) Pub. Date: Mar. 18, 2010

(54) ADAPTING CROSS-LINGUAL INFORMATION RETRIEVAL FOR A TARGET COLLECTION

(75) Inventors: Raghavendra Udupa, Bangalore (IN); Jagadeesh Jagarlamudi, Bangalore (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/208,246

(22) Filed: Sep. 10, 2008

(51) Int. Cl. G06F 17/28; G06F 17/30

(52) U.S. Cl. 704/7; 707/E17.001

(57) ABSTRACT

A method and system for generating a bilingual dictionary that maps words of the source language to words of a target language is provided. A Cross-Lingual Information Retrieval (“CLIR”) system accesses a parallel collection that is comprised of a parallel source collection and a parallel target collection, and generates a similarity score for sentences of the parallel target collection indicating the similarity of those sentences to sentences of the target collection. When the CLIR system generates a bilingual dictionary from the sentences of the parallel collection, it factors in the similarities of the sentences of the parallel target collection to sentences in the target collection. By factoring these similarities, the CLIR system allows sentences with a high similarity to have a greater influence on the mapping of words of the source language to the words of the target language than sentences with a low similarity.

### BACKGROUND

Millions of documents in many different languages are accessible via the Internet. These documents form collections that may include web pages, scholarly articles, news reports, governmental publications, and so on. Typically, search engines and other document retrieval systems input a query from a user in one language and search for documents within a collection that are in the same language. For example, a search engine may provide a web page for inputting queries in English, search for web pages that are in English, and display the search results as links to documents in English. Such systems, however, may not find many documents that are relevant to the query because they are in a language that is different from the language of the query. For example, a search engine when searching for web pages that match the query “Indian economic policy” may return many articles in English, but the most relevant document may be in Hindi.

Information retrieval researchers have developed Cross-Lingual Information Retrieval (“CLIR”) techniques to help users find relevant documents that are in languages different from the language of the queries submitted by the users. CLIR techniques need to map either the queries, the documents within a collection, or both to a common language. Because of the vast size of many document collections, it is impractical to translate such a large number of documents into different languages. Thus, CLIR techniques typically translate queries from their source language to the target language of a target collection. For example, a search engine may translate the query “Indian economic policy” to Hindi before searching a target collection whose target language is Hindi.

CLIR techniques may use machine translation systems or bilingual dictionaries to assist in the translation of a query from its source language to the target language of the target collection. Machine translation systems, however, typically do not provide effective translations of such queries in part because the machine translation systems may rely on syntactic or contextual information, which may not be available in short queries. Because of the limitations of machine translation systems, most CLIR techniques use a bilingual dictionary A bilingual dictionary maps words in a source language to corresponding words in a target language. CLIR techniques may use a bilingual dictionary to generate several different translations of a query, and then search for documents that match each of the queries. For example, the query “car jack” may be translated into multiple queries for a target language because the term “jack” has many different English definitions (e.g., a playing card and a lift for an automobile).

The effectiveness of a CLIR technique that uses a bilingual dictionary depends in large part on the quality and coverage of the bilingual dictionary. The quality refers to the ability of the bilingual dictionary to provide an accurate translation of a query, and the coverage refers to the ability of the bilingual dictionary to provide translations for a wide range of words. Bilingual dictionaries that are created manually typically have good quality but poor coverage. For example, bilingual dictionaries may be manually created for certain target domains, such as for travelers or the medical profession. As might be expected, a bilingual dictionary of medical terms would probably not provide acceptable translations for queries submitted by travelers.

Some CLIR techniques generate bilingual dictionaries automatically from a parallel collection. A parallel collection is a collection of documents in two different languages. For example, certain governments provide parallel collections by publishing their proceedings in multiple languages, such as English and French in Canada or English, French, and German in the European Union. As another example, news organizations may publish their news reports in multiple languages, such as Hindi and English. CLIR techniques may designate one of the languages of a parallel collection as a source language and another language as a target language. Word alignment techniques used by CLIR systems then automatically analyze the parallel collection to generate a bilingual dictionary mapping words of the source language to the corresponding words of the target language.

Parallel collections are typically published for very specific domains of information and thus do not provide good coverage for the words of a language. For example, a bilingual dictionary generated from the parliamentary proceedings of a government may not be particularly effective in translating queries submitted by travelers or medical professionals.

### SUMMARY

A method and system for generating a bilingual dictionary that maps words of the source language to words of a target language is provided. A Cross-Lingual Information Retrieval (“CLIR”) system accesses a parallel collection that is comprised of a parallel source collection and a parallel target collection. The parallel source collection has documents with sentences with words in a source language, and the parallel target collection has documents with sentences with words in a target language. Because the parallel collection and the target collection may be in different domains, the CLIR system generates similarity scores for sentences of the parallel target collection to indicate the similarity of those sentences to sentences of the target collection. When the CLIR system generates a bilingual dictionary from the sentences of the parallel collection, it factors in the similarity scores of the sentences of the parallel target collection to the sentences in the target collection. By factoring in the similarity, the CLIR system allows the sentences with a high similarity to have a greater influence on the mapping of words of the source language to the words of the target language than sentences with a low similarity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of a CLIR system in some embodiments.

FIG. 2 is a flow diagram that illustrates the processing of a generate dictionary component of the CLIR system in some embodiments.

FIG. 3 is a flow diagram that illustrates high-level processing of a generate similarity scores component of the CLIR system in some embodiments.

FIG. 4 is a flow diagram that illustrates low-level processing of a generate similarity scores component of the CLIR system in some embodiments.

FIG. 5 is a flow diagram that illustrates the processing of a create language model component of the CLIR system in some embodiments.

FIG. 6 is a flow diagram that illustrates the processing of a calculate score component of the CLIR system in some embodiments.

FIG. 7 is a flow diagram that illustrates the processing of a create dictionary component of the CLIR system in some embodiments.

### DETAILED DESCRIPTION

A method and system for generating a bilingual dictionary that maps words of a source language to words of a target language is provided. In some embodiments, a Cross-Lingual Information Retrieval (“CLIR”) system accesses a parallel collection that is comprised of a parallel source collection and a parallel target collection. The parallel source collection has documents with sentences with words in a source language, and the parallel target collection has documents with sentences with words in a target language. For example, the parallel collection may contain news articles published by a news agency in both English and Hindi. The CLIR system also accesses a target collection having documents with sentences with words in a target language, such as Hindi. Because the parallel collection and the target collection may be in different domains, the CLIR system generates similarity scores for sentences of the parallel target collection to indicate the similarity of those sentences to sentences of the target collection. For example, if the parallel collection contains news articles and the target collection contains travel web pages, then a news article about governmental travel restrictions may have sentences that are more similar to sentences of the target collection than a news article about constitutional reform. When the CLIR system generates a bilingual dictionary from the sentences of the parallel collection, it factors in the similarity score of the sentences of the parallel target collection to the sentences in the target collection. By factoring in the similarity scores, the CLIR system allows the sentences with a high similarity to have a greater influence on the mapping of words of the source language to the words of the target language than sentences with a low similarity score. The CLIR system may use various techniques for allowing sentences with a high similarity to have this greater influence. For example, the CLIR system may augment the parallel collection with duplicates of sentences with a high similarity (i.e., resampling) or may use the similarity score of the sentences when weighting possible translations of words of the sentences. In this way, the CLIR system automatically generates a bilingual dictionary that more accurately reflects the domain of the target collection than a bilingual dictionary generated without factoring in the similarity of sentences in the parallel target collection to sentences of the target collection. When the bilingual dictionary is used to translate a query from the source language to the target language, the translation is more likely to be appropriate to the domain of the target collection than if the bilingual dictionary were generated without factoring in the similarity of the sentences.

In some embodiments, the CLIR system may generate a bilingual dictionary that is specific to a query submitted by a user. For example, a user may be searching for documents in a target language that are similar to a query document in a source language. To generate the bilingual dictionary, the CLIR system generates a similarity score for each sentence of the query document indicating the similarity of each sentence to the sentences of the parallel source collection. For example, if the query document relates to travel and the parallel collection contains news articles, then sentences of the parallel source collection that are related to travel will likely have similarity scores indicating a greater similarity. As described above, the CLIR system then generates a bilingual dictionary factoring in the similarity scores of the sentences of the parallel source collection. Since the bilingual dictionary is generated by giving greater influence to sentences of the parallel collection that are similar to sentences of the query document, the translations generated using the bilingual dictionary are more likely to be appropriate to the domain of the query document than if the bilingual dictionary was generated without factoring in the similarity of the sentences. More generally, the CLIR system generates a bilingual dictionary factoring in the similarity of sentences of the parallel collection to sentences of an input having words. The input can correspond to the documents within the target collection, a query document, or some other input relating to a desired domain.

In some embodiments, the CLIR system generates similarity scores for sentences of a parallel collection based on a parallel collection language model and a target collection language model. A language model indicates the n-gram probabilities of each word of a collection occurring after each sequence of n-1 words in the collection. The n-gram probability of a word for a given sequence of n-1 words indicates the probability of that word following that sequence in the collection of documents. The n-gram probabilities for the words of the collection represent the language model of the collection. The CLIR system may select unigrams, bigrams, trigrams, and so on, based on empirical analysis of the quality of searches resulting from the use of different n-grams. The CLIR system generates the parallel collection language model based on the documents of the parallel target collection and generates the target collection language model based on the documents of the target collection. The CLIR system may use various smoothing techniques, such as back-off smoothing to account for any sparseness of n-grams in the collections.

After generating the language models, the CLIR system then generates a similarity score for each sentence in the parallel target collection that indicates whether the sentence is more similar to sentences of the target collection than the sentences of the parallel target collection. To generate the similarity score for a sentence, the CLIR system calculates a parallel collection probability score for the sentence using the parallel collection language model and a target collection probability score for the sentence using the target collection language model. The CLIR system calculates the probability score of a sentence by aggregating the n-gram probabilities of the words of the sentence. The CLIR system may aggregate the n-gram probabilities by multiplying the probabilities together, by summing a logarithm of the probabilities, and so on. The CLIR system may generate a similarity score for a sentence by dividing the target collection probability score for the sentence by the parallel collection similarity score for the sentence. Because the probability scores are divided, sentences that are more similar to sentences in the target collection than to sentences in the parallel collection will have a higher similarity score. A similarity score of 1.0 indicates that a sentence is equally similar to the sentences of each collection, a similarity score of 0.5 indicates that a sentence is more similar to the sentences of the parallel collection, and a similarity score of 1.5 indicates that the sentence is more similar to the sentences of the target collection. The CLIR system then generates a bilingual dictionary based on the parallel collection factoring in the similarity scores so that sentences that are more similar to sentences of the target collection than to sentences of the parallel collection have a greater influence on the mapping of words.

In some embodiments, the CLIR system may calculate similarity scores based on the cross entropy of probability distributions or the Renyi divergence of probability distributions. The CLIR system may represent the similarity scores based on cross entropy by the following equation:

$$δ ( W \vert S , T ) = {\sum }_{w} p ( w \vert W ) log ( \frac{p ( w \vert T )}{p ( w \vert S )} ) \qquad ( 1 )$$

where δ(W|S,T) represents the similarity score indicating whether the sentence W with words w is more similar to the sentences of target collection T than to the sentences of the parallel target collection S, p(w|W) represents the probability of word w in sentence W, p(w|T) represents the probability of word w in the target collection, and p(w|S) represents the probability of the word w in the parallel target collection. If the similarity score is greater than 0, then sentence W is more similar to the sentences of the target collection. Otherwise, sentence W is more similar to the sentences of the parallel target collection. If

$$\frac{p ( w \vert T )}{p ( w \vert S )}$$

is very large or very small for a word w, then the value of the term of

$$log ( \frac{p ( w \vert T )}{p ( w \vert S )} )$$

dominates the values for other words of the sentence W in Equation 1. To prevent such dominance, the CLIR may place an upper and lower bound on the possible values of

$$\frac{p ( w \vert T )}{p ( w \vert S )} .$$

The CLIR system may factor in the dependencies of words on their n-grams, which for bigrams may be represented by the following equation:

$$δ ( W \vert S , T ) = {\sum }_{< i , j > ∈ T} p ( {w}_{i} \vert {w}_{j} , W ) log ( \frac{p ( {w}_{i} \vert {w}_{j} , T )}{p ( {w}_{i} \vert {w}_{j} , S )} ) \qquad ( 2 )$$

where p(wᵢ|wⱼ, W) represents the probability of word wᵢ when the preceding word is word wᵢ in sentence W, p(wᵢ|wⱼ,T) represents the probability of word wᵢ when the preceding word is word wⱼ in the sentences of target collection T, and p(wᵢ|wⱼ,S) represents the probability of word wᵢ when the preceding word is word wⱼ in the sentences of parallel target collection S.

The CLIR system may alternatively represent the similarity scores based on a Renyi divergence by the following equation:

$$δ ( W \vert S , T ) = {\sum }_{w} p ( w \vert W ) \{ sgn ( 1 - α ) ( {( \frac{p ( w \vert T )}{p ( w \vert W )} )}^{1 - α} - {( \frac{p ( w \vert S )}{p ( w \vert W )} )}^{1 - α} ) \} \qquad ( 3 )$$

where sgn(1-α) represents the sign of 1-α and α represents a non-negative real number. As with the Equation 1, Equation 3 may have upper and lower bounds placed on its terms and may be modified to factor in n-gram dependencies.

The CLIR system may weight or resample a parallel collection based on cross entropy or Renyi divergence. The CLIR may resample the parallel collection according to a cross entropy-based distribution represented by the following equation:

$$q ( W ; γ ) = \frac{{e}^{γ δ ( W \vert S , T )}}{{\sum }_{{W}^{′}} {e}^{γ δ ( {W}^{′} \vert S , T )}} where γ \geq 0 \qquad ( 4 )$$

where e^{δ(W|S,T)} is represented by the following equation:

$${e}^{δ ( W ; S , T )} = {e}^{{\sum }_{w} p ( w \vert W ) log ( \frac{p ( w \vert T )}{p ( w \vert S )} )} = {\prod }_{w ∈ W} {( \frac{p ( w \vert T )}{p ( w \vert S )} )}^{p ( w \vert W )} = {\prod }_{w ∈ W} {( \frac{p ( w \vert T )}{p ( w \vert S )} )}^{\frac{C ( w ; W )}{n}} = {( \frac{{P}_{U} ( W \vert T )}{{P}_{U} ( W \vert S )} )}^{1 / n} \qquad ( 5 )$$

where P_{U}(W|T) represents the probability of sentence W based on the target collection language model, P_{U}(W|S) represents the probability of sentence W based on the parallel target collection language model, and C(w;W) represents the count of word w.

The CLIR may resample the parallel collection according to a Renyi divergence-based distribution represented by the following equation:

$$q ( W ; α , γ ) = \frac{{e}^{γ δ ( W \vert α , S , T )}}{{\sum }_{{W}^{′}} {e}^{γ δ ( {W}^{′} \vert α , S , T )}} where γ \geq 0 and α \geq 0 \qquad ( 6 )$$

where e^{δ(W|α,S,T)} is represented by the following equation:

$$\begin{matrix}{e}^{δ ( W ; α , S , T )} = {( \frac{{\sum }_{w} {p ( w \vert W )}^{α} {p ( w \vert T )}^{1 - α}}{{\sum }_{w} {p ( w \vert W )}^{α} {p ( w \vert S )}^{1 - α}} )}^{1 - α} \\ = {( \frac{{\sum }_{w} p ( w \vert W ) {( \frac{p ( w \vert T )}{p ( w \vert W )} )}^{1 - α}}{{\sum }_{w} p ( w \vert W ) {( \frac{p ( w \vert T )}{p ( w \vert W )} )}^{1 - α}} )}^{1 / ( 1 - α )} \\ = {( \frac{{E}_{p ( W )} [ {( \frac{p ( w \vert T )}{p ( w \vert W )} )}^{1 - α} ]}{{E}_{p ( W )} [ {( \frac{p ( w \vert S )}{p ( w \vert W )} )}^{1 - α} ]} )}^{1 / ( 1 - α )}\end{matrix} \qquad ( 7 )$$

where E_{p(w)} (X) represents the expectation of X based on probability p(W).

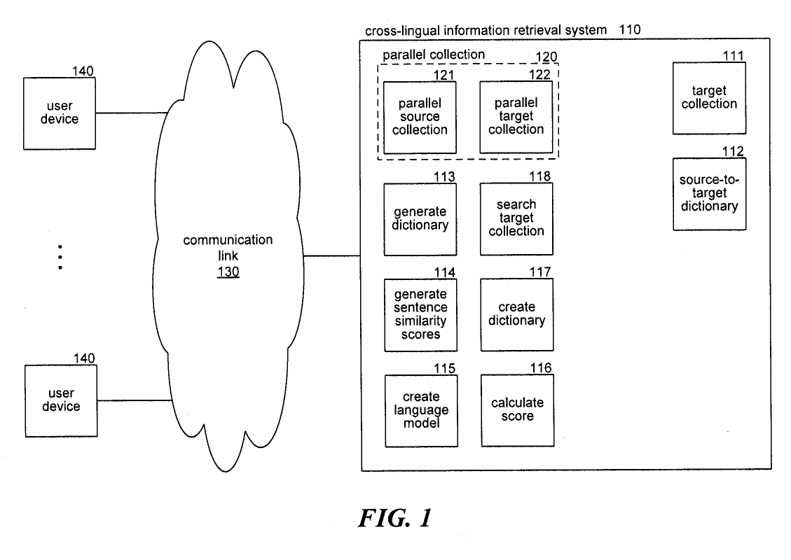

FIG. 1 is a block diagram that illustrates components of a CLIR system in some embodiments. A CLIR system 110 is connected to user devices 140 via communication link 130. The CLIR system includes a parallel collection 120, a target collection 111, and a source-to-target dictionary 112. The parallel collection is comprised of a parallel source collection 121 having documents in a source language and a parallel target collection 122 having corresponding documents in a target language. The target collection has documents in the target language. The source-to-target dictionary is a bilingual dictionary that maps words of the source language to words of the target language. The CLIR system also includes a generate dictionary component 113, a generate sentence similarity scores component 114, a create language model component 115, a calculate score component 116, a create dictionary component 117, and a search target collection component 118. The generate dictionary component invokes the generate sentence similarity scores component to generate similarity scores for sentences of the parallel target collection. The generate sentence similarity scores component invokes the create language model component to generate the parallel collection language model and the target collection language model. The generate sentence similarity score component also invokes the calculate score component to calculate the similarity scores for the sentences of the parallel collection. The generate dictionary component invokes the create dictionary component to create the bilingual dictionary based on the calculated sentence similarity scores. The search target collection component may correspond to a traditional cross-lingual search engine that inputs a query in the source language, generates translations of that query in the source language, and searches for documents of the target collection that match the translations of the query.

The computing device on which the CLIR system may be implemented may include a central processing unit, memory, input devices (e.g., keyboard and pointing devices), output devices (e.g., display devices), and storage devices (e.g., disk drives). The memory and storage devices are computer-readable storage media that may contain instructions that implement the CLIR system. In addition, the data structures and message structures may be stored or transmitted via a computer-readable data transmission medium, such as a signal on a communications link. Various communications links may be used, such as the Internet, a local area network, a wide area network, or a point-to-point dial-up connection. The computer-readable media include computer-readable storage media and computer-readable data transmission media.

The CLIR system may be implemented in and/or used by various operating environments. The operating environment described herein is only one example of a suitable operating environment and is not intended to suggest any limitation as to the scope of use or functionality of the CLIR. Other well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The CLIR system may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

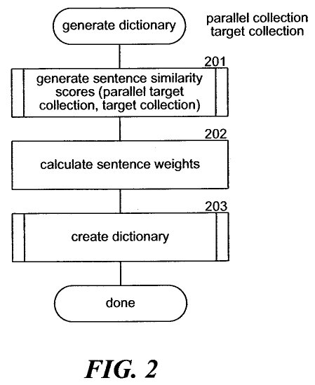

FIG. 2 is a flow diagram that illustrates the processing of a generate dictionary component of the CLIR system in some embodiments. The component is passed a parallel collection and a target collection and generates a bilingual dictionary. In block 201, the component invokes the generate sentence similarity scores component to generate similarity scores based on the parallel target collection and the target collection. In block 202, the component calculates sentence weights for the sentences of the parallel collection based on the similarity scores. In some embodiments, the sentence weights may be set to the similarity scores. In block 203, the component invokes the create dictionary component to create the bilingual dictionary based on the parallel collection and the sentence weights.

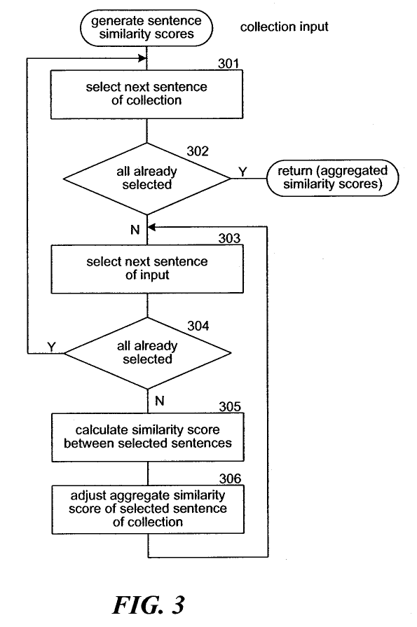

FIG. 3 is a flow diagram that illustrates the high-level processing of a generate similarity scores component of the CLIR system in some embodiments. The component is passed a collection and an input and generates similarity scores for sentences of the collection indicating their similarity to sentences of the input. As described above, the passed input can be a target collection and the passed collection can be a parallel target collection, or the passed input can be a query document and the passed collection can be a parallel source collection. In blocks 301-306, the component loops selecting each combination of pairs of sentences with one sentence from the input and the other sentence from the collection and calculating similarity scores. In block 301, the component selects the next sentence of the collection. In decision block 302, if all the sentences of the collection have already been selected, then the component returns the aggregated similarity scores, else the component continues at block 303. In block 303, the component selects the next sentence of the input to form a pair with the selected sentence of the collection. In decision block 304, if all the sentences of the input for the selected sentence of the collection have already been selected, then the component loops to block 301 to select the next sentence of the collection, else the component continues at block 305. In block 305, the component calculates a similarity score indicating the similarity between the selected sentences. In block 306, the component adjusts an aggregated similarity score for the selected sentence of the collection based on the calculated similarity score, and then loops to block 303 to select the next sentence of the input.

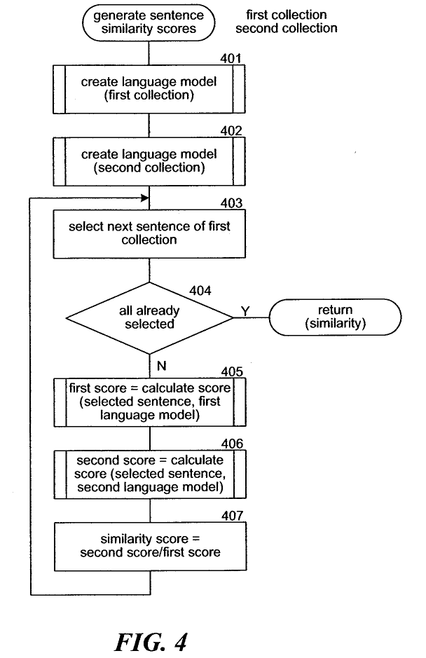

FIG. 4 is a flow diagram that illustrates the low-level processing of a generate similarity scores component of the CLIR system in some embodiments. The component is passed a first collection of documents and a second collection of documents in a target language and generates a first language model for the first collection and a second language model for the second collection. The first collection may be a parallel target collection and the second collection may be a target collection. In block 401, the component invokes a create language model component by passing the first collection to it to create a language model for the first collection. In block 402, the component invokes the create language model component by passing the second collection to it to create a language model for the second collection. In blocks 403-407, the component loops calculating similarity scores for the sentences of the first collection. In block 403, the component selects the next sentence of the first collection. In decision block 404, if all the sentences have already been selected, then the component returns the similarity scores, else the component continues at block 405. In block 405, the component invokes the calculate score component by passing the selected sentence and the first language model to it to generate a first score indicating the similarity of the selected sentence to the sentences of the first collection. In block 406, the component invokes the calculate score component by passing the selected sentence and the second language model to it to generate a second score indicating the similarity of the selected sentence to the sentences of the second collection. In block 407, the component calculates the similarity score by dividing the second score by the first score. The component then loops to block 403 to select the next sentence of the first collection.

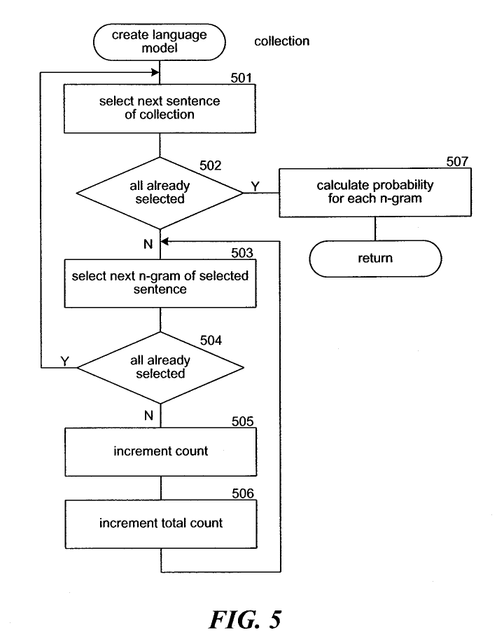

FIG. 5 is a flow diagram that illustrates the processing of a create language model component of the CLIR system in some embodiments. The component is passed a collection and generates a language model indicating n-gram probabilities of the collection. In blocks 501-506, the component loops, calculating counts of the n-grams in the collection. In a block 501, the component selects the next sentence of the collection. In decision block 502, if all the sentences have already been selected, then the component continues at block 507, else the component continues at block 503. In block 503, the component selects the next n-gram of the selected sentence. In decision block 504, if all the n-grams of the selected sentence have already been selected, then the component loops to block 501 to select the next sentence of the collection, else the component continues at block 505. In block 505, the component increments a count for the last word of the selected n-gram for the first n-1 words of the n-gram. In block 506, the component increments the total count of n-grams that have the same first n-1 words and then loops to block 503 to select the next n-gram of the selected sentence. In block 507, the component calculates the n-gram probabilities from the counts and the returns the n-gram probabilities.

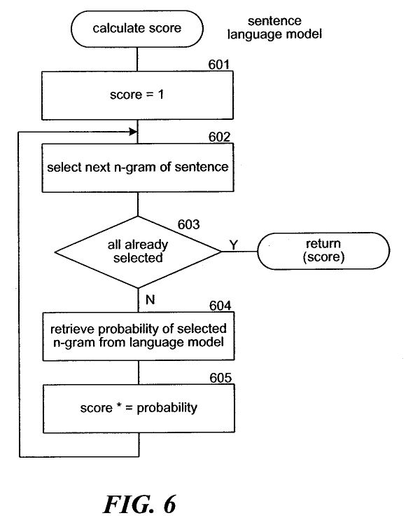

FIG. 6 is a flow diagram that illustrates the processing of a calculate score component of the CLIR system in some embodiments. The component is passed a sentence and a language model and generates a score indicating the probability of the language model generating the passed sentence. In block 601, the component initializes the score. In block 602, the component selects the next n-gram of the passed sentence. In decision block 603, if all the n-grams of the passed sentence have already been selected, then the component returns the score, else the component continues at block 604. In block 604, the component retrieves the probability for the selected n-gram from the passed language model. In block 605, the component aggregates the retrieved probability into the score for the sentence and then loops to block 605 to select the next n-gram of the sentence.

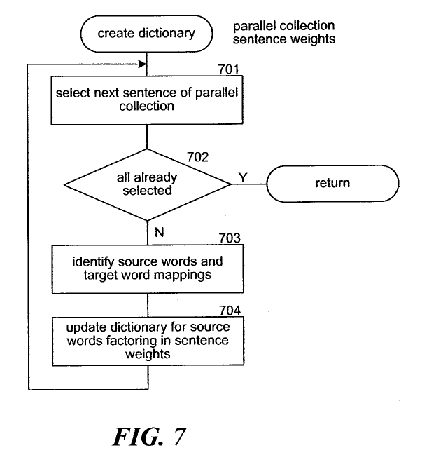

FIG. 7 is a flow diagram that illustrates the processing of a create dictionary component of the CLIR system in some embodiments. The component is passed a parallel collection and sentence weights (or similarity scores) and generates a bilingual dictionary based on the parallel collection and sentence weights. In block 701, the component selects the next sentence of the parallel collection. In decision block 702, if all the sentences have already been selected, then the component returns a bilingual dictionary, else the component continues at block 703. In block 703, the component identifies mappings of the source words and the target words of the selected sentence. In block 704, the component updates the dictionary for the source words factoring in the weight of the selected sentence, which may be based on resampling. The component then loops to block 701 to select the next sentence of the parallel collection.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims. Accordingly, the invention is not limited except as by the appended claims.

I/We claim:

1. A method in a computing device for generating a bilingual dictionary mapping words of a source language to words of a target language, the method comprising:
providing a target collection having documents with sentences with words in the target language;
providing a parallel collection having a parallel source collection having documents with sentences with words in the source language and a parallel target collection having documents with sentences with words in the target language;
generating a parallel collection language model for the parallel target collection, the parallel collection language model indicating probabilities of n-grams of words in the target language occurring in the parallel target collection;
generating a target collection language model for the target collection, the target collection language model indicating probabilities of n-grams of words in the target language occurring in the target collection;
for sentences in the parallel target collection,
calculating a parallel collection probability score for the sentence based on the parallel collection language model;
calculating a target collection probability score for the sentence based on the target collection language model; and
generating a similarity score for the sentence from the parallel collection probability score and the target collection probability score for the sentence, the similarity score indicating the likelihood of the sentence being more similar to sentences of the target collection than sentences of the parallel target collection; and
creating the bilingual dictionary from the sentences of the parallel collection factoring in the similarity scores of the sentences of the parallel target collection so that sentences with similarity scores indicating a greater likelihood of occurring in the target collection rather than the parallel target collection have a greater influence, than other sentences, on the mapping of words of the source language to words of the target language.

2. The method of claim 1 further including receiving a source query in the source language, generating a target query by translating the source query into the target language using the created bilingual dictionary, identifying documents of the target collection that are relevant to the target query, and providing the identified documents as search results for the source query.

3. The method of claim 1 wherein a probability score for a sentence is an aggregation of n-gram probabilities of n-grams of the sentence occurring in the collection used to generate the language model.

4. The method of claim 3 wherein the similarity score of a sentence is calculated by dividing the second similarity score for the sentence by the first similarity score for the sentence.

5. A computer-readable storage medium containing instructions for controlling a computing device to generate a bilingual dictionary mapping words of a source language to words of a target language, by a method comprising:
accessing a target collection having documents with sentences with words in the target language;
accessing a parallel collection having a parallel source collection having documents with sentences with words in the source language and a parallel target collection having documents with sentences with words in the target language;
for sentences of the parallel target collection, generating a similarity score for the sentence, the similarity score indicating the similarity of the sentence of the target collection; and
creating the bilingual dictionary from the sentences of the parallel collection factoring in the similarity scores of the sentences of the parallel target collection so that sentences with similarity scores indicating a greater similarity to sentences of the target collection have a greater influence, than other sentences, on the mapping of words of the source language to words of the target language.

6. The computer-readable storage medium of claim 5 wherein the generating of similarity scores for sentences includes:
generating a parallel target collection language model for the parallel target collection, the parallel target collection language model indicating probabilities of n-grams of words in the target language occurring in the parallel target collection;
generating a target collection language model for the target collection, the target collection language model indicating probabilities of n-grams of words in the target language occurring in the target collection; and
for sentences in the parallel target collection,
calculating a parallel target collection probability score for the sentence based on the parallel target collection language model;
calculating a target collection probability score for the sentence based on the target collection language model; and
generating a similarity score for the sentence from the parallel target collection probability score and the target collection probability score for the sentence, the similarity score indicating the likelihood of the sentence being more similar to sentences of the target collection than sentences of the parallel target collection.

7. The computer-readable storage medium of claim 6 wherein a probability score for a sentence is an aggregation of the probabilities of n-grams of the sentence occurring in the collection used to generate the language model.

8. The computer-readable storage medium of claim 5 further including receiving a source query in the source language, generating a target query by translating the source query into the target language using the created bilingual dictionary, identifying documents of the target collection that are relevant to the target query, and providing the identified documents as search results for the source query.

9. The computer-readable storage medium of claim 5 wherein the similarity score is based on a cross entropy calculation.

10. The computer-readable storage medium of claim 9 wherein the cross entropy calculation is represented by the following equation:
$$δ ( W \vert S , T ) = {\sum }_{w} p ( w \vert W ) log ( \frac{p ( w \vert T )}{p ( w \vert S )} )$$
where δ(W|S,T) represents the similarity score indicating whether the sentence W with words w is more similar to the sentences of target collection T than to the sentences of the parallel target collection S, p(w|W) represents the probability of word w in sentence W, p(w|T) represents the probability of word w in the target collection T, and p(w|S) represents the probability of the word w in the parallel target collections.

11. The computer-readable storage medium of claim 5 wherein the similarity score is based on a Renyi divergence calculation.

12. The computer-readable storage medium of claim 11 wherein the Renyi divergence calculation is represented by the following equation:
$$δ ( W \vert S , T ) = {\sum }_{w} p ( w \vert W ) \{ sgn ( 1 - α ) ( {( \frac{p ( w \vert T )}{p ( w \vert W )} )}^{1 - α} - {( \frac{p ( w \vert S )}{p ( w \vert W )} )}^{1 - α} ) \}$$
where sgn(1-α) represents the sign of 1-α and α represents a non-negative real number.

13. The computer-readable storage medium of claim 5 wherein the parallel collection and the target collection represent different domains.

14. The computer-readable storage medium of claim 5 wherein the creating of the bilingual dictionary further factors in the similarity of the sentences of the parallel source collection to a source query in the source language.

15. A computing device for generating a bilingual dictionary mapping words of a source language to words of a target language, comprising:
a parallel collection having a parallel source collection having documents with sentences with words in the source language and a parallel target collection having documents with sentences with words in the target language;
an input with words;
a component that generates, for sentences of the parallel collection, a similarity score for the sentence, the similarity score for each sentence indicating the similarity of the sentence to the input; and
a component that creates the bilingual dictionary from the sentences of the parallel collection factoring in the similarity scores of the sentences of the parallel collection so that sentences with similarity scores indicating a greater similarity to the input have a greater influence, than other sentences, on the mapping of words of the source language to words of the target language.

16. The computing device of claim 15 wherein the input is a source query with sentences with words in the source language.

17. The computing device of claim 15 wherein the input is a target collection with documents having sentences with words in the target language.

18. The computing device of claim 15 including:
a target collection having documents with sentences with words in the target language; and
a component that generates a translation of a source query in the source language into a target query in the target language using the created bilingual dictionary, identifies documents of the target collection that are relevant to the target query, and provides the identified documents as search results for the source query.

19. The computing device of claim 18 wherein the input is the source query.

20. The computing device of claim 15 wherein the component that generates a similarity scores
generates a parallel collection language model for the parallel collection, the parallel collection language model indicating probabilities of n-grams of words occurring in the parallel collection;
generates an input language model for the input, the input language model indicating probabilities of n-grams of words occurring in the input; and
for sentences in the parallel collection,
calculates a parallel collection probability score for the sentence based on the parallel collection language model;
calculates an input probability score for the sentence based on the input language model; and
generates a similarity score for the sentence from the parallel collection probability score and the input probability score for the sentence, the similarity score indicating the likelihood of the sentence being more similar to the input than sentences of the parallel collection.
